(19) United States
(12) Patent Application Publication
(10) Pub. No.: US 2016/0005374 A1
(43) Pub. Date: Jan. 7, 2016

(54) DISPLAY DRIVING CIRCUIT AND OUTPUT BUFFER CIRCUIT THEREOF

(71) Applicant: SILICON WORKS CO., LTD., Daejeon-si (KR)

(72) Inventors: Young Bok KIM, Daejeon-si (KR); Young Tae KIM, Seoul (KR); Hyun Kyu JEON, Daejeon-si (KR); Joon Ho NA, Daejeon-si (KR)

(21) Appl. No.: 14/792,811

(22) Filed: Jul. 7, 2015

(30) Foreign Application Priority Data
Jul. 7, 2014 (KR) 10-2014-0084650

(51) Int. Cl. G09G 3/36

(52) U.S. Cl. CPC G09G 3/3696; G09G 2330/021

(57) ABSTRACT

Provided are an output buffer circuit capable of outputting a pair of output signals having different polarities and a display driving circuit including the same. The output buffer circuit includes output buffers which output a positive output signal and a negative output signal in response to a pair of input signals having different polarities. As the output buffers are driven while sharing a common voltage, the output buffer circuit satisfies a low-power specification, and has a stable electrical characteristic.

### BACKGROUND

1. Technical Field

The present disclosure relates to a display driving circuit, and more particularly, to an output buffer circuit for outputting a pair of output signals having different polarities and a display driving circuit including the same.

2. Related Art

A liquid crystal display (LCD) device is used in a display device. The LCD device may display a screen using an optical shutter function based on the electrical characteristic of liquid crystal, and include a source driver, a gate driver, and a timing controller in order to drive the liquid crystal.

A data signal has information for displaying a screen and is transmitted to the source driver from the timing controller, and the source driver provides an output signal corresponding to the data signal to a display panel.

The display panel may include an LCD panel. When the LCD panel provides only data signals having the same polarity, the LCD panel may have difficulties in forming a normal screen due to a liquid crystal driving error. In order to solve such a problem, the polarity inversion technology may be generally employed. The polarity inversion technology is to remove a liquid crystal driving error by alternately providing output signals having different polarities (positive and negative) to the same line of the LCD panel through a source driver integrated circuit.

Hereafter, the source driver will be referred to as a display driving circuit. The display driving circuit may include a digital block and an output unit. The digital block may process a data signal, and the output unit may convert a signal outputted from a digital-to-analog converter and provide the converted signal to the display panel. The digital block may be designed to perform signal processing using a low voltage, and the output unit may be designed to be driven by a high voltage.

The display driving circuit may output a larger number of output signals, and include a large number of output units as illustrated in FIG. 1. For convenience of description, FIG. 1 illustrates that the output unit receives a pair of input signals IN(N) and IN(N+1) having different polarities and outputs a pair of output signals OUT(N) and OUT(N+1) having different polarities.

The output unit of FIG. 1 may include an output buffer circuit 100, an output switch 14, and a charge sharing switch 16. The output buffer circuit 100 may include a pair of output buffers 10 and 12.

The output buffer circuit 100 may be configured to receive the pair of input signals IN(N) and IN(N+1) having different polarities and output a pair of output signals OP and ON having different polarities.

In the output buffer circuit 100, the output buffer 10 includes a receiver circuit 11 and an output circuit to output the output signal OP corresponding to the input signal IN(N), and the output circuit includes a PMOS transistor P10 and an NMOS transistor N10 which are complementarily coupled to each other.

The output buffer 10 receives an analog voltage corresponding to a data signal as the input signal IN(N), converts the input signal IN(N) in response to an internal load, and outputs the output signal OP. The operation of receiving the input signal IN(N) and converting the input signal IN(N) in response to the internal load is performed by the receiver circuit 11, and the operation of driving and outputting the signal converted by the receiver circuit 11 as the output signal OP is performed by the PMOS transistor P10 and the NMOS transistor N10 which are complementarily coupled to each other.

In the output buffer circuit 100, the output buffer 12 includes a receiver circuit 13 and an output circuit to output the output signal ON corresponding to the input signal IN(N+1), and the output circuit includes a PMOS transistor P12 and an NMOS transistor N12 which are complementarily coupled to each other to form the output circuit.

The output buffer 12 receives an analog voltage corresponding to a data signal as the input signal IN(N+1), converts the input signal IN(N+1) in response to an internal load, and outputs the output signal OM. The operation of receiving the input signal IN(N+1) and converting the input signal IN(N+1) in response to the internal load is performed by the receiver circuit 13, and the operation of driving and outputting the signal converted by the receiver circuit 13 as the output signal ON is performed by the PMOS transistor P10 and the NMOS transistor N10, which are complementarily coupled to each other to form the output circuit.

The output signal OP of the output buffer 10 corresponds to a positive output signal, and the output signal ON of the output buffer 12 corresponds to a negative output signal. That is, the output signals OP and ON have complementary polarities.

The output switch 14 includes switches SF1 and SF2 and switches SC1 and SC2. The switches SF1 and SF2 directly output the output signal OP of the output buffer 10 and the output signal ON of the output buffer 12 as the output signals OUT(N) and OUT(N+1), respectively, and the switches SC1 and SC2 output the output signal OP of the output buffer 10 and the output signal ON of the output buffer 12 as the output signals OUT(N+1) and OUT(N), respectively.

The charge sharing switch 16 may include a switch SE configured between output lines of the output signal OUT(N) and the output signal OUT(N+1). The switch SE is turned on at a period in which the output signals OUT(N) and OUT(N+1) are deactivated, and stabilizes the voltage levels of the output lines.

The output buffer circuit 100, the output switch 14, and the charge sharing switch 16 of the display driving circuit of FIG. 1 may be implemented with high-voltage transistors.

More specifically, when the display driving circuit is designed to be fabricated through a low-voltage process of 1.8V and a high-voltage process of 9V, the output buffer circuit 100, the output switch 14, and the charge sharing switch 16 are designed to use the high-voltage process of 9V. A transistor fabricated through the low-voltage process may be referred to as a low-voltage transistor, and a transistor fabricated through the high-voltage process may be referred to as a high-voltage transistor. That is, a transistor fabricated through the high-voltage process of 9V may have a withstanding voltage capable of withstanding a gate-source voltage VGS of 9V and a drain-source voltage VDS of 9V.

FIG. 1 illustrates the case in which an operating voltage VDD for driving a high-voltage transistor is used as it is. In this case, the operating voltage may be defined as a full operating voltage. VTop represents a full operating voltage, and VBottom represents a ground voltage.

The display driving circuit using the full operating voltage as illustrated in FIG. 1 is difficult to apply to a product requiring a low-power specification. Thus, the display driving circuit needs to be designed to satisfy the low-power specification.

### SUMMARY

Various embodiments are directed to a display driving circuit which can be designed to satisfy a low-power specification, and an output buffer circuit thereof.

Also, various embodiments are directed to a display driving circuit which satisfies a low-power specification, has an advantage in terms of a chip size, and has a stable electrical characteristic, and an output buffer circuit thereof.

Also, various embodiments are directed to an output buffer circuits which includes output buffers configured to output a positive output signal and a negative output signal in response to a pair of input signals having different polarities and implemented with low-voltage transistors, satisfies a low-power specification as the output buffers are driven while sharing a common voltage, and has a stable electrical characteristic, and a display driving circuit having the same.

In an embodiment, an output buffer circuit of a display driving circuit may include: a first output buffer configured to output a first output signal to a display panel using a first voltage and a common voltage lower than the first voltage in response to a first input signal; and a second output buffer configured to output a second output signal to the display panel using the common voltage and a second voltage lower than the common voltage in response to a second input signal. The first output buffer may include one or more first NMOS transistors driven by the common voltage in order to receive the first input signal or output the first output signal, the second output buffer may include one or more second NMOS transistors driven by the second voltage in order to receive the second input signal or output the second output signal, and the first NMOS transistor may be electrically isolated so as to be prevented from being shorted to the second NMOS transistor via a substrate.

In another embodiment, a display driving circuit may include: a first output buffer configured to output a first output signal to a display panel using a first voltage and a common voltage lower than the first voltage in response to a first input signal; a second output buffer configured to output a second output signal to the display panel using the common voltage and a second voltage lower than the common voltage in response to a second input signal; and a switching circuit configured to output the first and second output signals to first and second output terminals. The switching circuit may be implemented with a high-voltage transistor, and the first and second output buffers may be implemented with a low-voltage transistor which is driven by a driving voltage lower than the high-voltage transistor and has a lower withstanding voltage than the high-voltage transistor.

### BRIEF DESCRIPTION OF THE DRAWINGS

FIG. 1 is a circuit diagram of a conventional display driving circuit.

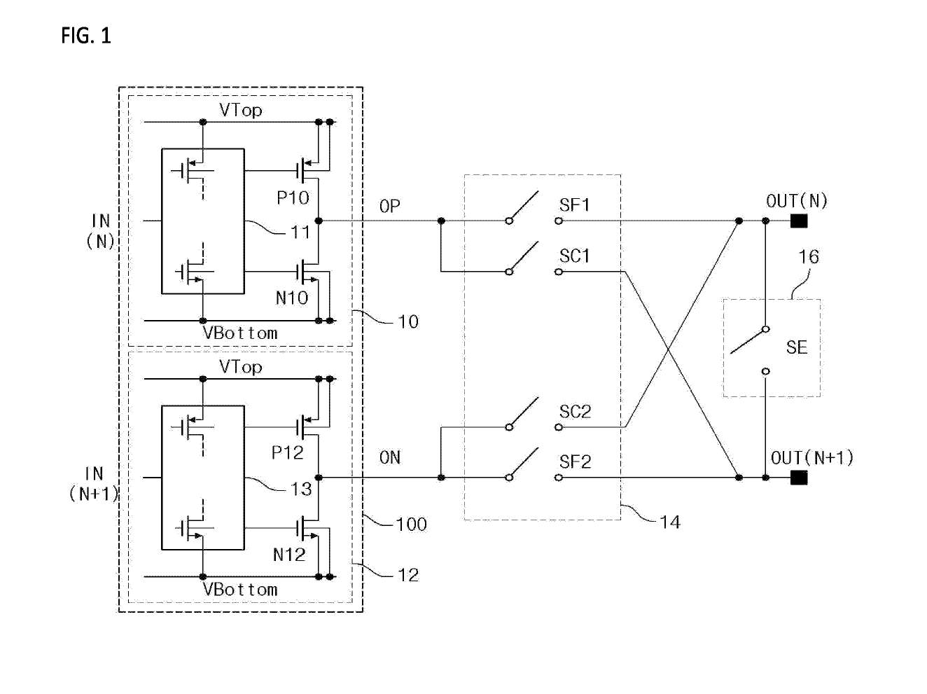

FIG. 2 is a circuit diagram illustrating a display driving circuit in accordance with an embodiment of the present invention.

FIG. 3 is a cross-sectional view for describing the formation of a current path when isolation of an NMOS transistor included in an output buffer of an output buffer circuit is excluded.

FIG. 4 is a cross-sectional view illustrating isolation of the NMOS transistor included in the output buffer of the output buffer circuit.

FIG. 5 is a cross-sectional for describing the isolation in the embodiment of FIG. 4.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

The embodiments of the present invention disclose a display driving circuit including output buffers 20 and 22 which share a common voltage such that an output buffer circuit 200 satisfies the low-power specification.

In the embodiments of the present invention, the common voltage may indicate an intermediate potential between a first voltage used for driving the output buffer 20 and a second voltage used for driving the output buffer 22. When the first voltage is a full operating voltage VTop and the second voltage is a ground voltage VBottom, the common voltage may be set to a half operating voltage HVDD. That is, when the full operating voltage VTop serving as the first voltage is 9V and the ground voltage VBottom serving as the second voltage is 0V, the common voltage, that is, the half operating voltage HVDD may be set to 4.5V. Furthermore, when the first voltage is a positive operating voltage PVDD and the second voltage is a negative operating voltage NVDD, the common voltage may be set to a ground voltage GND. That is, when the positive operating voltage PVDD serving as the first voltage is 4.5V and the negative operating voltage NVDD serving as the second voltage is −4.5V, the common voltage, that is, the ground voltage GND may be set to 0V. The ground voltage may be represented by VBottom and GND, but set to the same voltage.

A display driving circuit in accordance with an embodiment of the present invention may correspond to a part including an output buffer circuit which provides a high-voltage output signal to a display panel. Representatively, the part may include a source driver or gate driver. In the embodiment of the present invention, the source driver will be taken as an example for description. Furthermore, in the following descriptions for the configuration and operation of the display driving circuit in accordance with the embodiment of the present invention, the first voltage may indicate the full operating voltage VTop, and the second voltage may indicate the ground voltage VBottom. However, the embodiment of the present invention is not limited thereto.

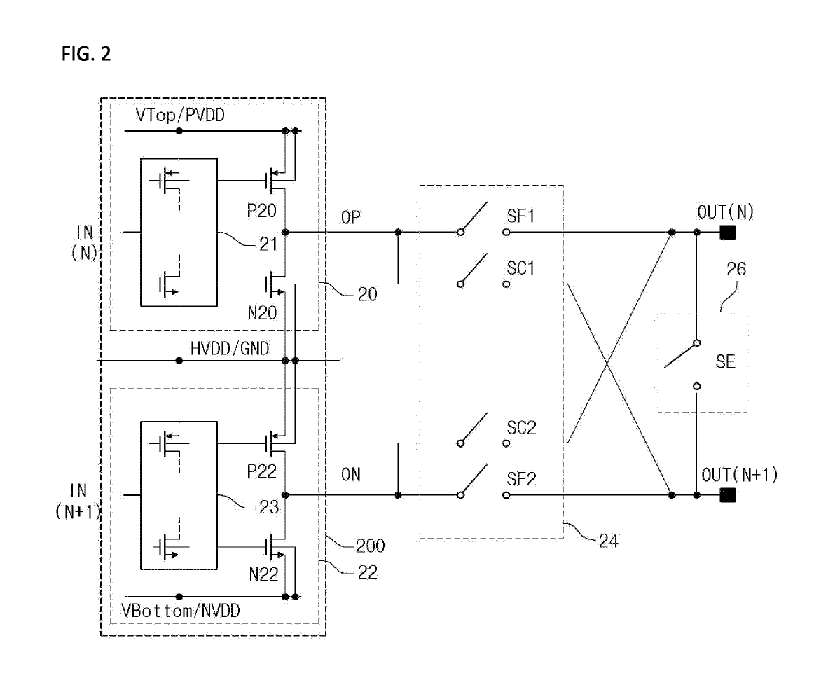

The display driving circuit in accordance with the embodiment of the present invention may include an output unit which converts a signal outputted from a digital-to-analog converter in response to a data signal and provides the converted signal to a display panel, as illustrated in FIG. 2.

The display driving circuit may output a large number of output signals, and include a large number of output units corresponding to the output signals as illustrated in FIG. 2. For convenience of description, FIG. 2 illustrates that the output unit receives a pair of input signals IN(N) and IN(N+1) having different polarities and outputs a pair of output signals OUT(N) and OUT(N+1).

The display driving circuit of FIG. 2 may include an output buffer circuit 200, an output switch 24, and a charge sharing switch 26. The output buffer circuit 200 may include a pair of output buffers 20 and 22.

The output buffer circuit 200 may be configured to receive the pair of input signals IN(N) and IN(N+1) having different polarities and output a pair of output signals OP and ON.

In the output buffer circuit 200, the output buffer 20 includes a receiver circuit 21 and an output circuit to output the output signal OP corresponding to the input signal IN(N), and the output circuit includes a PMOS transistor P20 and an NMOS transistor N20 which are complementarily coupled to each other.

The receiver circuit 21 may be configured to use the full operating voltage VTop and the half operating voltage HVDD for operation. The receiver circuit 21 may convert the input signal IN(N) in response to an internal load and output the converted signal. The receiver circuit 21 may be configured to provide the same signal to the PMOS transistor P20 and the NMOS transistor N20.

The PMOS transistor P20 may have a gate configured to receive the output signal of the receiver circuit 21, corresponding to the input signal IN(N), a source and body configured to receive the full operating voltage VTop, and a drain commonly connected to the drain of the NMOS transistor N20. The NMOS transistor N20 may have a gate configured to receive the output signal of the receiver circuit 21, corresponding to the input signal IN(N), a source and body configured to receive the half operating voltage HVDD, and the drain commonly connected to the drain of the PMOS transistor P20. The output circuit including the PMOS transistor P20 and the NMOS transistor N20 may output the output signal OP through a node commonly connected to the drains thereof. That is, when the receiver circuit 21 provides a high-level output signal, the PMOS transistor P20 may be turned off, and the NMOS transistor N20 may be turned on. As a result, the output signal OP may be pull-down driven to the half operating voltage HVDD. On the other hand, when the receiver circuit 21 provides a low-level output signal, the PMOS transistor P20 may be turned on, and the NMOS transistor N20 may be turned off. As a result, the output signal OP may be pull-up driven to the full operating voltage VTop.

As described above, the output buffer 20 may be configured to output the output signal OP corresponding to the input signal IN(N).

In the output buffer circuit 200, the output buffer 22 includes a receiver circuit 23 and an output circuit to output the output signal ON corresponding to the input signal IN(N+1), and the output circuit includes a PMOS transistor P22 and an NMOS transistor N22 which are complementarily coupled to each other.

The receiver circuit 23 may be configured to use the half operating voltage HVDD and the ground voltage VBottom for operation. The receiver circuit 23 may convert the input signal IN(N+1) in response to an internal load and output the converted signal. The receiver circuit 23 may be configured to provide the same signal to the PMOS transistor P22 and the NMOS transistor N22.

The PMOS transistor P22 may have a gate configured to receive the output signal of the receiver circuit 23, corresponding to the input signal IN(N+1), a source and body configured to receive the half operating voltage HVDD, and a drain commonly connected to the drain of the NMOS transistor N22. The NMOS transistor N22 may have a gate configured to receive the output signal of the receiver circuit 23, corresponding to the input signal IN(N+1), a source and body configured to receive the ground voltage VBottom, and the drain commonly connected to the drain of the PMOS transistor P22. The output circuit including the PMOS transistor P22 and the NMOS transistor N22 may output the output signal ON through a node commonly connected to the drains thereof. That is, when the receiver circuit 23 provides a high-level output signal, the PMOS transistor P22 may be turned off, and the NMOS transistor N22 may be turned on. As a result, the output signal ON may be pull-down driven to the ground voltage VBottom. On the other hand, when the receiver circuit 23 provides a low-level output signal, the PMOS transistor P22 may be turned on, and the NMOS transistor N22 may be turned off. As a result, the output signal ON may be pull-up driven to the half operating voltage HVDD.

As described above, the output buffer 22 may be configured to output the output signal ON corresponding to the input signal IN(N+1).

The output signal OP of the output buffer 20 and the output signal ON of the output buffer 22 have different polarities in response to the input signal IN(N) and the input signal IN(N+1) having different polarities. The output signal OP of the output buffer 20 may be defined as a positive output signal, and the output signal ON of the output buffer 22 may be defined as a negative output signal.

The output switch 24 may include switches SF1 and SF2 and switches SC1 and SC2. The switches SF1 and SF2 may directly output the output signal OP of the output buffer 20 and the output signal ON of the output buffer 22, and the switches SC1 and SC2 may cross and output the output signal OP of the output buffer 20 and the output signal ON of the output buffer 22.

According to the above-described configuration, the output switch 24 may alternately perform first and second switching operations. During the first switching operation, the output switch 24 may directly output a positive output signal, that is, the output signal OP as the output signal OUT(N), and directly output a negative output signal, that is, the output signal ON as the output signal OUT(N+1). During the second switching operation, the output switch 24 may output the output signal OP as the output signal OUT(N+1), and output the output signal ON as the output signal OUT(N). For the first switching operation, the switches SF1 and SF2 may be turned on, and the switches SC1 and SC2 may be turned off. For the second switching operation, the switches SF1 and SF2 may be turned off, and the switches SC1 and SC2 may be turned on. Furthermore, the first and second switching operations may be performed through typical control using a control signal (not illustrated) synchronized with an output enable signal.

The charge sharing switch 26 may include a switch SE configured between output lines of the output signal OUT(N) and the output signal OUT(N+1). The switch SE may be turned on at a period in which the output signals OUT(N) and OUT(N+1) are deactivated, and precharge and stabilize the voltage levels of the output lines.

In the embodiment configured as illustrated in FIG. 2, the transistors included in the receiver circuits 21 and 22 and the output circuits included in the respective output buffers 20 and 22 of the output buffer circuit 200 may be driven in a low-voltage environment of 4.5V. Furthermore, the transistors included in the receiver circuits 21 and 22 and the output circuits included in the respective output buffers 20 and 22 may be fabricated through a low-voltage process of 4.5V, and thus have a withstanding voltage capable of withstanding a gate-source voltage VGS of 4.5V and a drain-source voltage VDS of 4.5V.

In the above-described embodiment, as the output buffer circuit 200 is driven in the low-voltage environment, power consumption can be expected to be reduced.

Furthermore, the transistors included in the output switch 24 and the charge sharing switch 26 may be driven in a high-voltage environment of 9V, 18V, or 32V. That is, the transistors included in the output switch 24 and the charge sharing switch 26 may include high-voltage transistors which are fabricated through the high-voltage process of 9V, 18V, or 32V.

Furthermore, the transistors of the receiver circuits 21 and 23 and the output circuits included in the respective output buffers 20 and 22 may have a smaller channel length than the transistors included in the output switch 24 and the charge sharing switch 26. Thus, the output buffer circuit 200 in accordance with the embodiment of the present invention may be implemented with transistors having a small area, thereby reducing the chip area.

Furthermore, the transistors of the receiver circuits 21 and 23 and the output circuits included in the respective output buffers 20 and 22 may have a lower turn-on resistance (Ron resistance) than the transistors included in the output switch 24 and the charge sharing switch 26. Thus, the transistors of the receiver circuits 21 and 23 and the output circuits included in the respective output buffers 20 and 22 may have an improved electrical delay characteristic. Furthermore, in order to improve the delay characteristic of the transistors of the output circuits and the receiver circuits 21 and 23 included in the respective output buffers 20 and 22, the chip size does not need to be increased. Thus, the chip area can be additionally reduced.

When the embodiment of the present invention is configured as illustrated in FIG. 2, the NMOS transistor N20 among the transistors of the receiver circuit 21 and the output circuit included in the output buffer 20 needs to be electrically isolated in order to prevent a short circuit to the substrate. That is, electrical isolation of the NMOS transistor N20 may be required.

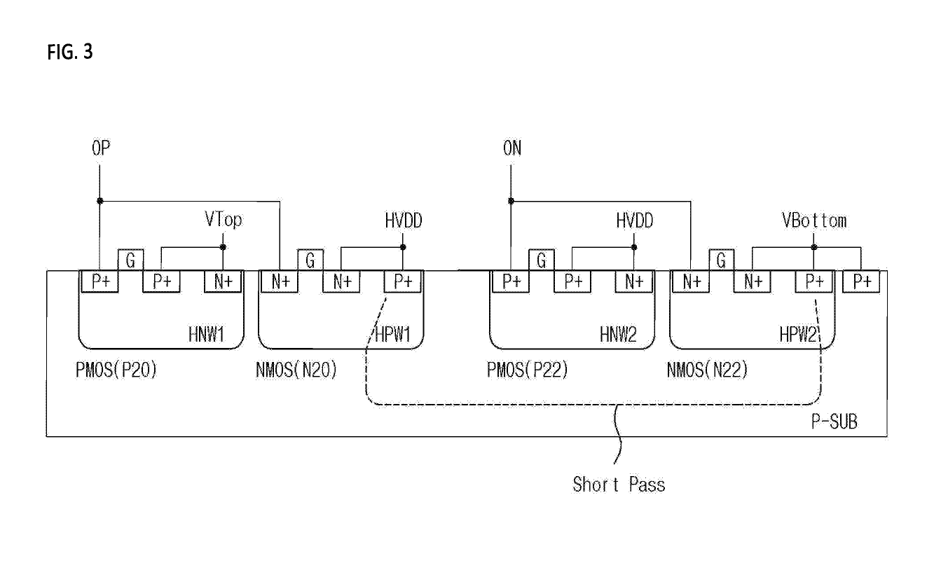

The electrical isolation of the NMOS transistor N20 will be described with reference to FIGS. 3 to 5.

FIG. 3 is a diagram for describing that a short pass is formed when the electrical isolation of the NMOS transistor N20 included in the output buffer 20 is excluded as illustrated in FIG. 2. FIG. 3 illustrates the configurations of the PMOS transistor P20 and the NMOS transistor N20 of the output buffer 20 and the PMOS transistor P22 and the NMOS transistor N22 of the output buffer 22.

The substrate may include a P-type substrate P-SUB having N-wells HNW1 and HNW2 and P-wells HPW1 and HPW2 formed in divided regions thereof. The PMOS transistor P20, the NMOS transistor N20, the PMOS transistor P22, and the NMOS transistor N22 will be formed in the N-wells HNW1 and HNW2 and the P-wells HPW1 and HPW2. The N-well HNW1 and the P-well HPW1 may be formed for the PMOS transistor P20 and the NMOS transistor N20 of the output buffer 20, and the N-well HNW2 and the P-well HPW2 may be formed for the PMOS transistor P22 and the NMOS transistor N22 of the output buffer 22.

In order to form the PMOS transistors P20 and P22, P-type contacts P+, an N-type contact N+, and a gate layer G may be formed. The P-type contacts P+ may form a drain and source in each of the N-wells HNW1 and HNW2, the N-type contact N+ may form a body in each of the N-wells NHW1 and HNW2, and the gate layer G may form a gate over the region at which the P-type contacts P+ forming the drain and source are isolated from each other.

Furthermore, in order to form the NMOS transistors N20 and N22, N-type contacts N+, a P-type contact P+, and a gate layer G may be formed. The N-type contacts N+ may form a drain and source in each of the P-wells HPW1 and HPW2, the P-type contact P+ may form a body in each of the P-wells HPW1 and HPW2, and the gate layer G may form a gate over regions at which the N-type contacts N+ forming the drain and source are isolated from each other.

In the above configuration, the half operating voltage HVDD may be applied to the N-type contacts N+ forming the source of the NMOS transistor N20 and the P-type contact P+ forming the body of the NMOS transistor N20, and the ground voltage VBottom may be applied to the N-type contacts N+ forming the source of the NMOS transistor N22 and the P-type contact forming the body of the NMOS transistor N22.

At this time, the P-type contact P+, the P-well HPW1, and the P-type substrate P-SUB, which form the body of the NMOS transistor N20, may be shorted by a potential difference between the half operating voltage HVDD and the ground voltage VBottom. As a result, a short pass may be formed, which includes the P-type contact P+ forming the body of the NMOS transistor N20, the P-well HPW1, the P-type substrate P-SUB, and the P-well HPW2, and the P-type contact P+ forming the body of the NMOS transistor N12.

In this case, a normal operation of the output buffer circuit 100 cannot be guaranteed.

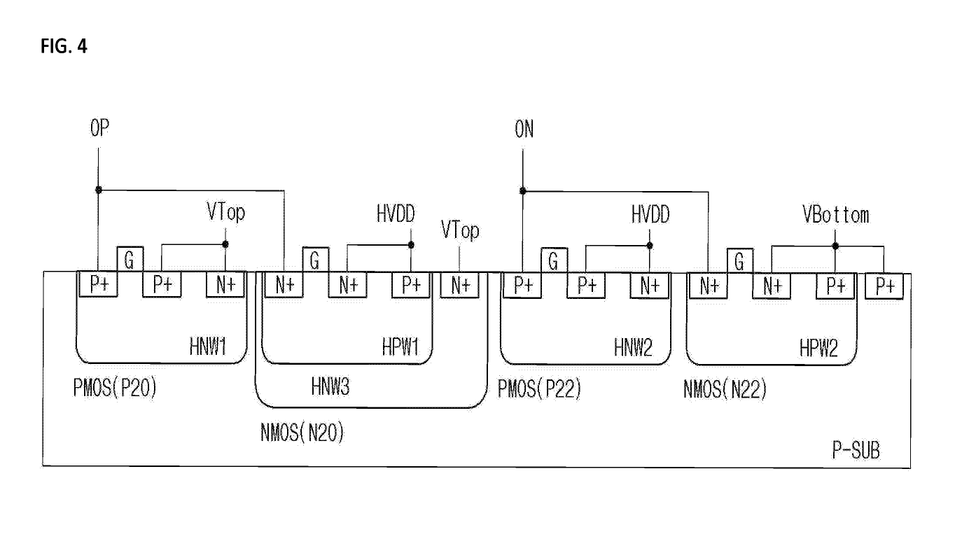

In order to solve the problem caused by the formation of the short pass described with reference to FIG. 3, the display driving circuit in accordance with the embodiment of the present invention may include an element structure for electrically isolating the NMOS transistor N20 as illustrated in FIG. 4.

The output buffer circuit 200 of FIG. 4 may be formed on the P-type substrate P-SUB as illustrated in FIG. 3, and include N-wells HNW1 and HNW2 and P-wells HPW1 and HPW2 formed in divided regions of the P-type substrate P-SUB. The PMOS transistor P20, the NMOS transistor N20, the PMOS transistor P22, and the NMOS transistor N22 will be formed in the N-wells HNW1 and HNW2 and the P-wells HPW1 and HPW2. Since the PMOS transistor P20, the NMOS transistor N20, the PMOS transistor P22, and the NMOS transistor N22 are configured in the same manner as illustrated in FIG. 3, the duplicate descriptions thereof are omitted herein.

The P-well HPW1 forming the NMOS transistor N20 included in the output buffer 20 may be housed in an N-well HNW3, and the N-well HNW3 may prevent a short fail which occurs when an electrical pass is formed between the NMOS transistor N20 and the P-type substrate P-SUB. The N-well HNW3 may be defined as an N-type isolation-well.

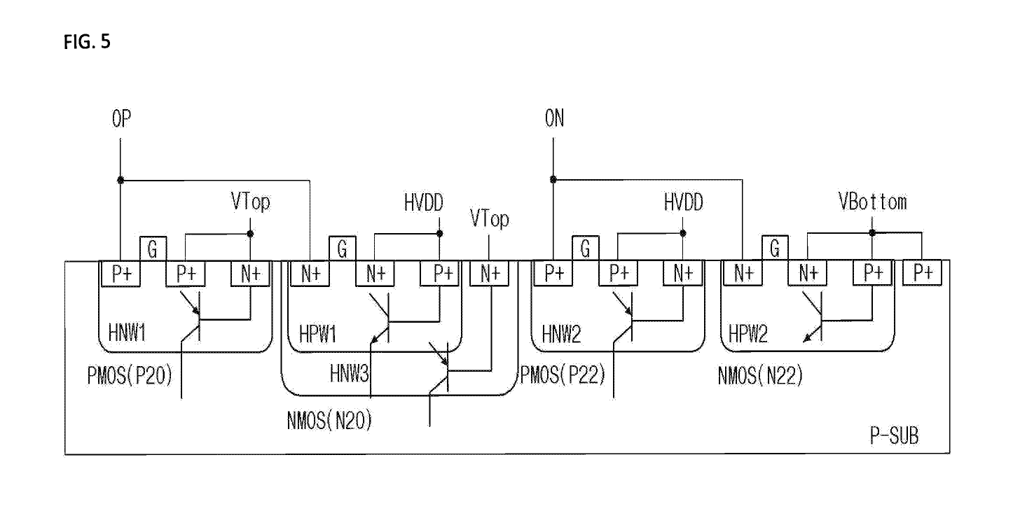

The short blocking operation will be described with reference to FIG. 5. FIG. 5 illustrates an equivalent circuit for describing the short blocking operation based on the cross-sectional view of FIG. 4.

First, the same voltage may be applied to the sources and bodies of the PMOS transistor P20, the NMOS transistor N20, the PMOS transistor P22, and the NMOS transistor N22, in order to control a threshold voltage.

Furthermore, in order to prevent floating of the P-type substrate P-SUB, the ground voltage VBottom may be applied to the P-type substrate P-SUB through a P-type contact P+.

Furthermore, in order to block the formation of an electrical pass between the NMOS transistor N20 and the P-type substrate P-SUB, the full operating voltage VTop may be applied to the N-type isolation well HNW3 through an N-type contact N+.

At this time, a P-type contact P+ serving as the source of the NMOS transistor N20, the P-type well HPW12, and the N-type isolation well HNW3 may be expressed as an equivalent NPN bipolar transistor which is controlled by the half operating voltage HVDD applied to the body of the NMOS transistor N20. At this time, the full operating voltage VTop is already applied to the N-type isolation well HNW3 serving as an emitter on the equivalent NPN bipolar transistor. Thus, the turn-on of the equivalent NPP bipolar transistor may be blocked regardless of the base voltage thereof.

Furthermore, the P-type well HPW1, the N-type isolation well HNW3, and the P-type substrate P-SUB may be expressed as an equivalent PNP bipolar transistor which is controlled by the full operating voltage VTop. Since the high-level full operating voltage VTop is applied to the N-type isolation well HNW3 through the base on the equivalent PNP bipolar transistor, the turn-on of the N-type isolation well HNW3 may be blocked.

That is, a short between the NMOS transistor N20 and the P-type substrate P-SUB may be prevented. As a result, a short pass may be blocked, which includes the P-type contact P+ forming the body of the NMOS transistor N20, the P-well HPW1, the P-type substrate P-SUB, the P-well HPW2, and the P-type contact P+ forming the body of the NMOS transistor N12.

Thus, among the transistors included in the output buffer 20 of the output buffer circuit 200 in accordance with the embodiment of the present invention, the NMOS transistor N20 may be blocked from being shorted to the P-type substrate P-SUB through the operation of the N-type isolation well HNW3 or the formation of a short pass through the P-type substrate P-SUB may be blocked. Thus, since the threshold voltages of the transistors included in the output buffer circuit 200 can be stabilized, a normal operation of the output buffer circuit 200 can be guaranteed.

As described above, the output buffer circuit 200 in accordance with the embodiment of the present invention may employ transistors fabricated through a low-voltage process. Without an electrical or physical problem, the output buffer circuit 200 can be normally driven in a low-voltage environment using a command voltage.

Thus, the display driving circuit and the output buffer circuit thereof can be designed to satisfy the low-power specification.

Furthermore, the display driving circuit and the output buffer circuit can reduce the chip size, and have a stabilized electrical characteristic.

While various embodiments have been described above, it will be understood to those skilled in the art that the embodiments described are by way of example only. Accordingly, the disclosure described herein should not be limited based on the described embodiments.

What is claimed is:

1. An output buffer circuit of a display driving circuit, comprising:
a first output buffer configured to output a first output signal to a display panel using a first voltage and a common voltage lower than the first voltage in response to a first input signal; and
a second output buffer configured to output a second output signal to the display panel using the common voltage and a second voltage lower than the common voltage in response to a second input signal,
wherein the first output buffer comprises one or more first NMOS transistors driven by the common voltage in order to receive the first input signal or output the first output signal,
the second output buffer comprises one or more second NMOS transistors driven by the second voltage in order to receive the second input signal or output the second output signal, and
the first NMOS transistor is electrically isolated so as to be prevented from being shorted to the second NMOS transistor via a substrate.

2. The output buffer circuit of claim 1, wherein the first input signal and the second input signal have different polarities.

3. The output buffer circuit of claim 1, wherein the first NMOS transistor is configured to receive the common voltage as a body voltage.

4. The output buffer circuit of claim 1, wherein the first NMOS transistor is formed in a P-well formed within an N-type isolation well, and the first NMOS transistor and the substrate are electrically isolated from each other by the N-type isolation well.

5. The output buffer circuit of claim 4, wherein the first voltage is biased to the N-type isolation well.

6. The output buffer circuit of claim 1, wherein the first voltage comprises a driving voltage, the second voltage comprises a ground voltage, and the common voltage is set to ½ level of the driving voltage.

7. The output buffer circuit of claim 1, wherein the common voltage is set to a ground level.

8. A display driving circuit comprising:
a first output buffer configured to output a first output signal to a display panel using a first voltage and a common voltage lower than the first voltage in response to a first input signal;
a second output buffer configured to output a second output signal to the display panel using the common voltage and a second voltage lower than the common voltage in response to a second input signal; and
a switching circuit configured to output the first and second output signals to first and second output terminals,
wherein the switching circuit is implemented with a high-voltage transistor, and the first and second output buffers are implemented with a low-voltage transistor which is driven by a driving voltage lower than the high-voltage transistor and has a lower withstanding voltage than the high-voltage transistor.

9. The display driving circuit of claim 8, wherein the first output buffer comprises one or more first NMOS transistors which are driven by the common voltage in order to receive the first input signal or output the first output signal and correspond to the low-voltage transistor,
the second output buffer comprises one or more second NMOS transistors which are driven by the second voltage in order to receive the second input signal or output the second output signal and correspond to the low-voltage transistor, and
the first NMOS transistor is electrically isolated so as to be prevented from being shorted to the second NMOS transistor via the substrate.

10. The display driving circuit of claim 9, wherein the first NMOS transistor is formed in a P-well formed within an N-type isolation well, and the first NMOS transistor and the substrate are electrically isolated from each other by the N-type isolation well.

11. The display driving circuit of claim 10, wherein the first voltage is biased to the N-type isolation well.

12. The display driving circuit of claim 1, wherein the first input signal and the second input signal have different polarities.
